(19) United States
(12) Patent Application Publication
(10) Pub. No.: US 2003/0043358 A1
(43) Pub. Date: Mar. 6, 2003

(54) Methods for determining focus and astigmatism in charged-particle-beam microlithography

(75) Inventors: Wakako Suganuma, Tokyo (JP); Takehisa Yahiro, Agea-shi (JP)

Correspondence Address: KLARQUIST SPARKMAN, LLP, One World Trade Center, Suite 1600, 121 S.W. Salmon Street, Portland, OR, 97240, US

(73) Assignee: Nikon Corporation

(21) Appl. No.: 10/233,083

(22) Filed: Aug. 30, 2002

(30) Foreign Application Priority Data
Aug. 31, 2001 (JP) 2001-263182

(51) Int. Cl. G03B 27/42

(52) U.S. Cl. 355/53

(57) ABSTRACT

Evaluation methods are disclosed for evaluating the image-forming performance of charged-particle-beam microlithography systems, especially with regard to astigmatism and focus. In an embodiment, a subfield containing an evaluation pattern is subdivided into multiple regions. In the various regions, the respective line-and-space (L/S) pattern elements are oriented such that the elements in one region extend in a direction that intersects the direction, in the object plane of orientation of the pattern element in another region. The evaluation pattern is transferred lithographically to a resist film on a substrate. The developed resist, when observed at a magnification at which individual L/S pattern elements are not resolved, reveals a “shadow region” having a particular profile. The profile is a function of one or more parameters (e.g., astigmatism and focus) of image-forming performance.

### FIELD

This disclosure pertains to microlithography, which is a key technology used in the fabrication of micro-electronic devices such as semiconductor integrated circuits, displays, and the like. More specifically, the disclosure pertains, in the context of microlithography performed using a charged particle beam, to methods for evaluating the image-forming performance of the charged-particle-beam (CPB) optical system as used in a CPB microlithography system. Such image-forming evaluations include, for example, astigmatism and focusing. The disclosure also is directed to methods for adjusting the microlithography system based on data obtained from the image-forming evaluations.

### BACKGROUND

As the sizes of active circuit elements in micro-electronic devices have continued to decrease, with concurrent increases in device-packing density, the development of “next-generation” lithography (NGL) systems and related methods has been rapid. Currently favored approaches to NGL technology utilize very short wavelengths of light (specifically, “extreme ultraviolet”, or “EUV”, light) and charged particle beams (specifically, electron beams and ion beams) in an effort to produce finer pattern resolution than currently obtainable using conventional optical microlithography.

Regarding charged-particle-beam (CPB) microlithography, developments in electron-beam lithography have been especially rapid. An electron beam has an excellent propensity to propagate in a straight line, and thus is well-suited for making microlithographic exposures of extremely fine patterns. At the time electron-beam microlithography made its debut, patterns were “drawn” line-by-line on the substrate using an electron beam. This technique exhibited extremely low throughput, especially in contrast to optical microlithography in which an entire pattern can be exposed from the reticle to the substrate in a single “shot.” Unfortunately, electron-beam microlithography currently is incapable of transferring an entire pattern from a reticle to a substrate in a single shot. But, to obtain substantially better throughput than obtained using the line-by-line drawing technique, the pattern as defined on the reticle is divided into a large number of portions, termed “subfields,” each defining a respective set of pattern elements. The subfields are exposed individually in a sequential manner in respective shots onto the substrate. The respective images of the subfields are positioned accurately on the substrate so as to achieve proper “stitching” of the images into a contiguous entire pattern on the substrate. This technique is termed the “divided-reticle” transfer-exposure technique.

Divided-reticle transfer-exposure has been shown capable of resolving 70-nm pattern elements, especially with recent improvements in the performance of resists applied to the substrate surface. It is anticipated that, with upcoming demands for circuit elements having dimensions of 50 nm or less, beam astigmatism and focal position will have significant impacts on pattern resolution. Currently, the size of a subfield as projected onto the wafer using an electron beam has dimensions of 250 μm square. With such dimensions a high beam-acceleration voltage is used, but the current density per unit area is low. Under such conditions, it is difficult to adjust astigmatism or focus using a mark-scanning waveform as used in conventional variable-shaped-beam exposure methods.

Hence, in conventional divided-reticle transfer-exposure, after completing transfer-exposure of the entire pattern to the resist layer on the surface of the substrate, the pattern actually formed in the resist is measured to evaluate astigmatism and resolution. Correction of astigmatism is performed using an astigmatism-correction coil (“stigmator”) situated in the electron-beam optical system upstream of the substrate. An exemplary conventional stigmator is shown in FIGS. 8(A)-8(B), wherein FIG. 8(A) is a plan view of the stigmator coils, and FIG. 8(B) is a schematic diagram of the operating principles of the coils shown in FIG. 8(A). The stigmator 100 comprises two sets of quadrupole coils A and B. The two sets of quadrupole coils are disposed so that the coils A-1 to A-4 in the set A and the coils B-1 to B-4 in the set B are positioned altematingly. The respective axis of each coil is oriented radially and at a right angle to the optical axis (the Z-axis), and the individual coil axes are oriented 45° apart from each other. The two sets A, B of coils are connected to and driven by respective power supplies 103a, 103b, respectively. Note that the coils of each set are connected together in series to the respective power supply.

Operation of the stigmator 100 is described with reference now to FIG. 8(B), depicting only the coils A-1 to A-4 of the first set A of quadrupole coils. As electrical current flows from the respective power supply to the four coils of the set, the coils generate respective magnetic fields (indicated by respective lines of force). An electron beam traveling in the Z-direction (perpendicular to the plane of the page) near the optical axis is influenced by the magnetic fields and is laterally deflected (according to Fleming's left-hand rule) in the directions indicated by the white arrows. Thus, the portion of an electron beam of which the transverse section extends diagonally from the upper right corner to the lower left corner in the figure is urged, by deflection, toward the optical axis. Similarly, the portion of the beam of which the transverse section extends diagonally from the upper left corner to the lower right corner in the figure is urged, by deflection, away from the optical axis. As a result, the aerial image carried by the electron beam passing in a generally axial direction through the stigmator of FIG. 8(B) is compressed in a first lateral direction and expanded in a second lateral direction orthogonal to the first lateral direction. These compressions and expansions cancel astigmatism extending in directions opposite the directions of compression and expansion. A similar expansion and contraction action is achieved by the other set B of coils. By controlling the current supplied from the respective power supplies to the coil sets, astigmatism in the various directions is corrected.

For establishing optimal astigmatism adjustments to be made by the stigmator, a layer of resist on a downstream substrate is exposed under conditions in which the current supplied to the stigmator coils is varied according to a predetermined pitch. The resulting patterns formed in the exposed resist are observed under a scanning electron microscope (SEM) at a magnification of 10,000× or more. Based on the results of this observation, the stigmator is adjusted so as to produce optimal resolution.

To correct focus, electrical current supplied to a focus-adjustment coil in the electron-beam optical system is varied while exposing a pattern multiple times under respective conditions in which the convergence point for the beam is moved axially “up” and “down.” The resulting images are observed by SEM to determine an adjustment to the focus-adjustment coil appropriate for achieving optimal resolution.

Evaluation patterns used for adjustments to astigmatism and focus normally are patterns in which constituent line-and-space (L&S) elements are disposed “vertically” and “horizontally” (i.e., in X and Y directions) in subfields of a reticle. A line element of such a pattern can have multiple widths ranging from the resolution-limited linewidth to several times the resolution-limited linewidth. For performing the evaluation, first a reticle is used on which the evaluation pattern is formed in a large number of subfields. As each subfield is exposed, three parameters (the current supplied to the focus-adjustment coil and the respective currents supplied to the two coil sets of the stigmator) are varied stepwise. After completing exposure, the wafer is developed, and the pattern thus formed is observed by SEM. The subfield pattern having the best resolution is determined, and the respective combination of parameters used for exposing that subfield is selected as optimal exposure conditions.

Determining optimal conditions for correcting astigmatism and focus as described above requires exposing a substrate each instance in which the current supplied to the focus-adjustment coil and the respective currents supplied to the two coil sets in the stigmator are varied, and observing the developed pattern by SEM. These operations must be performed on a number (tens or hundreds) of subfields equal to the number of parameters multiplied by the number of conditions involved. As a result, these operations are very time-consuming. In addition, evaluation of focus and astigmatism by SEM requires considerable experience to perform in a manner yielding useful data.

### SUMMARY

In view of the shortcomings of the prior art as summarized above, the present invention provides, inter alia, improved methods for evaluating the image-forming performance (e.g., astigmatism and/or focus) of a charged-particle-beam (CPB) microlithography system, wherein the evaluation and adjustment of the imageforming performance can be performed simply and efficiently.

One aspect of the invention is directed to methods set forth in the context of a microlithography method in which a device pattern to be transferred to a photosensitive substrate is defined on a reticle situated at a reticle plane. A region of the reticle is illuminated with an illumination beam to form a patterned beam that carries an image, via a projection-optical system, of the illuminated region to the photosensitive substrate so as to form an image of the illuminated region on the photosensitive substrate. The subject methods are for determining the imageforming performance of the projection-optical system. In an embodiment of such a method, an evaluation pattern is disposed at the reticle plane. The evaluation pattern comprises multiple groups of line-and-space (L/S) pattern elements, each group comprising multiple L/S pattern elements extending in a respective direction that intersects a respective direction, in the reticle plane, of L/S pattern elements in another of the groups. The evaluation pattern is lithographically imaged on a resist-coated substrate, and the resist on the substrate is developed to form in the resist an imprinted image of the evaluation pattern. Observations are made of a “shadow region” (as described herein) in the imprinted image of the evaluation pattern. From the observed profile of the shadow region, the image-forming performance is determined. The image-forming performance can be focus or astigmatism, or both.

Desirably, the L/S pattern elements have a linewidth at or near a resolution limit of the projection-optical system.

The evaluation pattern can be divided into multiple regions, wherein each region comprises a respective group of L/S pattern elements. The respective L/S pattern elements in each of at least two regions are oriented differently from each other in respective directions that intersect each other in the reticle plane. For example, the respective L/S pattern elements in each of at least two regions can be oriented perpendicularly to each other. In each group, the constituent L/S pattern elements can be parallel to each other. Alternatively, in each of multiple regions each comprising a respective group of L/S pattern elements, the constituent L/S pattern elements can extend radially relative to a center of the subfield. Further alternatively, in each of multiple regions each comprising a respective group of L/S pattern elements, the constituent L/S pattern elements can extend circumferentially relative to a center of the subfield.

The evaluation pattern can be defined on a reticle subfield divided into multiple regions. In this configuration, each region comprises a respective group of L/S pattern elements. The respective L/S pattern elements in each group are disposed around a center of the evaluation pattern.

In this method embodiment, the observing step desirably is performed using an optical microscope, which allows easy and rapid observations with minimal operator training.

The shadow regions arise generally from a gradual increase or decrease in a linewidth of the as-imaged L/S pattern due to a proximity effect caused by different cumulative exposure energies from a center of the imprinted image to a perimeter of the imprinted image of the evaluation pattern. The shadow regions can have any of several profiles. For example, the shadow region can have at least one arc-shaped profile having a respective radius, wherein the radius decreases with increasing resolution with which the evaluation pattern is lithographically imaged from the reticle to the substrate, resulting in a positional shift of the shadow region, with increasing resolution, toward a center of the imprinted image of the evaluation pattern. In this embodiment the multiple groups of L/S pattern elements can be disposed around a center of the evaluation pattern. If the image-forming performance pertains to astigmatism, then astigmatism is determined by observing an increased radius of a respective arc-shaped profile in a first location of the imprinted evaluation pattern at which a blur direction caused by the astigmatism is similar to a direction in which L/S pattern elements in the first location extend, and observing a decreased radius of a respective arc-shaped profile in a second location of the imprinted evaluation pattern at which a blur direction caused by the astigmatism is approximately 90° to the direction in which L/S pattern elements in the first location extend. If the image-forming performance pertains to focus, then the shadow region can have a ring-shaped profile of which a radius is a function of focus, wherein focus is determined by observing the radius of the ring-shaped profile of the shadow region. The radius can be a function of the extent to which an image-forming capacity of the resist matches a position of the resist in an axial direction.

The shadow region can have an arc-shaped profile having a radius that is a function of a resolution with which the L/S pattern elements have been imaged in at least one direction on the photosensitive substrate. Alternatively or in addition, the shadow region can have an arc-shaped profile having a radius that is a function of a blur accompanying imaging of the L/S pattern elements in at least one direction on the photosensitive substrate.

If the resist is a negative resist and the incident dose is greater than a “pivotal-point” dose, then the darker the image, the lower a resolution at which the evaluation pattern was imaged onto the substrate. On the contrary, if the incident dose is less than the pivotal-point dose, then the darker the image, the higher a resolution at which the evaluation pattern was imaged onto the substrate. The “pivotal-point dose” is the incident dose at which line elements develop in an exposed negative resist (or spaces develop in an exposed positive resist) with no changes in linewidth occurring with changes in blur. Actual pivotal-point doses are established by properties of the resist, and may vary from one type or brand of resist to another. If the resist is a positive resist and the incident dose is less than the pivotal-point dose, then the darker the image, the lower a resolution at which the evaluation pattern was imaged onto the substrate.

Another aspect of the invention also is set forth in the context of a microlithography method performed using a microlithography apparatus in which a device pattern to be transferred to a photosensitive substrate is defined on a reticle situated at a reticle plane. A region of the reticle is illuminated with an illumination beam to form a patterned beam that carries an image, via a projection-optical system, of the illuminated region to the photosensitive substrate so as to form an image of the illuminated region on the photosensitive substrate. The subject method of this aspect is directed to determining and adjusting an imaging-forming performance of the microlithography apparatus. An embodiment of such a method comprises setting a condensing power of the projection-optical system, setting a focus with which the image of the illuminated region is imaged on the photosensitive substrate, and setting an astigmatism with which the image of the illuminated region is imaged on the photosensitive substrate. Also, an evaluation pattern is disposed at the reticle plane. The evaluation pattern comprises multiple groups of L/S pattern elements, wherein each group comprises multiple L/S pattern elements extending in a respective direction that intersects a respective direction, in the reticle plane, of L/S pattern elements in another of the groups. The evaluation pattern is lithographically imaged on a resist-coated substrate multiple times, wherein in each time at least one of focus and astigmatism is changed, so as to form. multiple respective images of the evaluation pattern on the photosensitive substrate at various respective settings of focus and astigmatism. The resist on the substrate is developed to form in the resist respective imprinted images of the evaluation pattern. Respective shadow regions in the imprinted images of the evaluation pattern are observed. From respective observed profiles of the shadow regions, desired settings of focus and astigmatism are determined and selected.

As noted above, the L/S pattern elements desirably have a linewidth at or near a resolution limit of the projection-optical system

The multiple groups of L/S pattern elements desirably are disposed around a center of the evaluation pattern. With such a configuration of the evaluation pattern, astigmatism can be determined by observing an increased radius of a respective arc-shaped profile in a first location of the imprinted evaluation pattern at which a blur direction caused by the astigmatism is similar to a direction in which L/S pattern elements in the first location extend, and observing a decreased radius of a respective arc-shaped profile in a second location of the imprinted evaluation pattern at which a blur direction caused by the astigmatism is approximately 90° to the direction in which L/S pattern elements in the first location extend.

The shadow region can have a ring-shaped profile of which a radius is a function of focus, wherein focus is determined by observing the radius of the ring-shaped profile of the shadow region.

The foregoing and additional features and advantages of the invention will be more readily apparent from the following detailed description, which proceeds with reference to the accompanying drawings.

### BRIEF DESCRIPTION OF THE DRAWINGS

FIGS. 1(A)-1(B) are plan views of respective astigmatism-evaluation patterns as described in the first representative embodiment, and of corresponding dark regions, observable using a low-power optical microscope, formed when the patterns are exposed onto a negative-resist-coated wafer under certain astigmatism conditions.

FIG. 2 is an elevational schematic diagram showing the overall configuration of an embodiment of a charged-particle-beam microlithography system of which the optical system is evaluated using an astigmatism-evaluation pattern according to, e.g., any of the representative embodiments described herein.

FIG. 3 is a plan view of an astigmatism-evaluation pattern as described in the second representative embodiment, and of corresponding dark regions, observable using a low-power optical microscope, formed when the pattern is exposed onto a negative-resist-coated wafer under certain astigmatism conditions.

FIG. 4 is a two-dimensional matrix of various shapes of dark regions that are formed on a negative resist from the evaluation pattern of the first representative embodiment, under respective conditions of relative energization of two coil sets in a stigmator such as that shown in FIG. 8(A).

FIG. 5 is a one-dimensional matrix of various shapes of dark regions that are formed on a negative resist from an exemplary evaluation pattern as the focal point of the pattern image is changed.

FIG. 6 is a plan view of an astigmatism-evaluation pattern according to the third representative embodiment.

FIG. 7 is a plan view of an alternative astigmatism-evaluation pattern according to the third representative embodiment.

FIGS. 8(A)-8(B) depict the configuration of an exemplary stigmator, wherein FIG. 8(A) is a plan view showing both sets of coils of the stigmator, and FIG. 8(B) is a plan view showing certain operational principles of the coil set “A” shown in FIG. 8(A).

FIGS. 9(A)-9(B) are respective plots of certain parameters affecting the configuration and location of dark regions on a negative resist exposed with an astigmatism-evaluation pattern, wherein FIG. 9(A) is a plot of the distribution of mean residual resist thickness in a subfield, and FIG. 9(B) is a plot of the distribution of exposure dose in a subfield.

### DETAILED DESCRIPTION

The invention is described below in the context of representative embodiments, which are not to be regarded as limiting in any way.

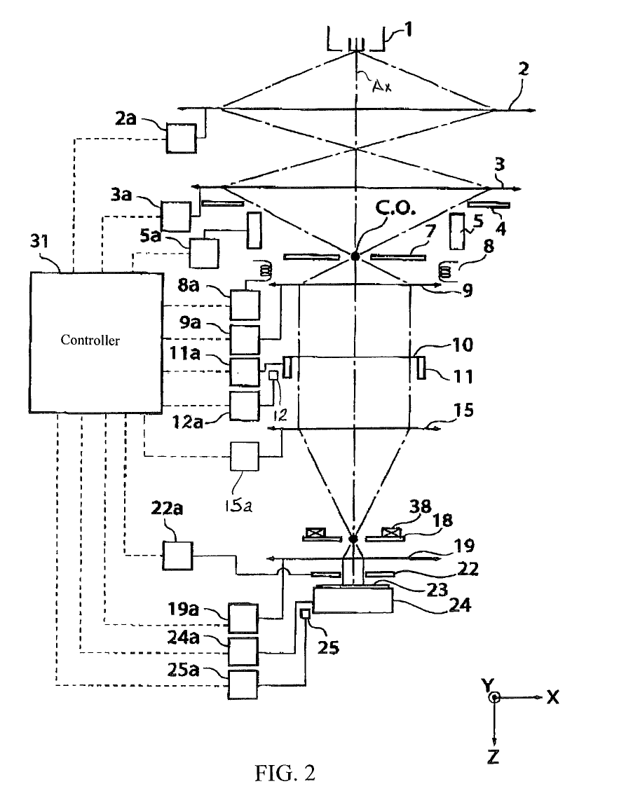

FIG. 2 shows an overview of a CPB divided-reticle projection-microlithography system. The depicted system utilizes an electron beam as an exemplary charged particle beam. Situated at the extreme upstream end of the system is an electron gun 1 that emits an electron beam propagating in a downstream direction generally along an optical axis Ax. Downstream of the electron gun 1 are a first condenser lens 2 and a second condenser lens 3 collectively constituting a two-stage condenser-lens assembly. The condenser lenses 2, 3 converge the electron beam at a crossover C.O. situated on the optical axis Ax at a blanking diaphragm 7.

Downstream of the second condenser lens 3 is a “beam-shaping diaphragm” 4 comprising a plate defining an axial aperture (typically rectangular in profile) that trims and shapes the electron beam passing through the aperture. The aperture is sized and configured to trim the electron beam sufficiently to illuminate one subfield on the divided reticle 10 per shot. An image of the beam-shaping diaphragm 4 is formed on the reticle 10 by an illumination lens 9.

The electron-optical components situated between the electron gun 1 and the reticle 10 collectively constitute an “illumination-optical system” of the depicted microlithography system. The electron beam propagating through the illumination-optical system is termed an “illumination beam” because it illuminates a desired region of the reticle 10. As the illumination beam propagates through the illumination-optical system, the beam actually travels in a downstream direction through an axially aligned “beam tube” (not shown but well understood in the art) that can be evacuated to a desired vacuum level.

A blanking deflector 5 is situated downstream of the beam-shaping aperture 4. The blanking deflector 5 laterally deflects the illumination beam as required to cause the illumination beam to strike the aperture plate of the blanking diaphragm 7, thereby preventing the illumination beam from being incident on the reticle 10.

A subfield-selection deflector 8 is situated downstream of the blanking diaphragm 7. The subfield-selection deflector 8 laterally deflects the illumination beam as required to illuminate a desired subfield on the reticle within the optical field of the illumination optical system. Thus, the subfields of the reticle 10 are scanned sequentially by the illumination beam in a horizontal direction (X direction in the figure). The illumination lens 9, which forms the image of the beam-shaping diaphragm 4 on the reticle 10, is situated downstream of the subfield-selection deflector 8.

The divided reticle 10 typically defines many subfields (e.g., tens of thousands of subfields) and may be manufactured using any of the methods discussed below. The subfields collectively define the pattern for a layer to be formed at a single die (“chip”) on a lithographic substrate. The reticle 10 is mounted on a movable reticle stage 11. Using the reticle stage 11, by moving the reticle 10 in a direction (Y and/or X direction) perpendicular to the optical axis Ax, it is possible to illuminate the respective subfields on the reticle 10 extending over a range that is wider than the optical field of the illumination-optical system. The position of the reticle stage 11 in the XY plane is determined using a “position detector” 12 typically configured as a laser interferometer. The laser interferometer is capable of measuring the position of the reticle stage 11 with extremely high accuracy in real time.

Situated downstream of the reticle 10 are first and second projection lenses 15, 19, respectively. The illumination beam, by passage through an illuminated subfield of the reticle IO, becomes a “patterned beam” because the beam has acquired an aerial image of the illuminated subfield. The patterned beam is imaged at a specified location on a substrate 23 (e.g., “wafer”) by the projection lenses 15, 19 collectively functioning as a “projection-lens assembly.”

So as to be imprintable with the image carried by the patterned beam, the upstream-facing surface of the substrate 23 is coated with a suitable “resist” that is imprintably sensitive to exposure by the patterned beam. A resist-coated substrate is termed herein “photosensitive,” whether the resist is sensitive to exposure by electromagnetic radiation or a charged particle beam. When forming the image on the substrate, the projection-lens assembly “reduces” (demagnifies) the aerial image. Thus, the image as formed on the substrate 23 is smaller (usually by a defined integer-ratio factor termed the “demagnification factor,” such as 1/4) than the corresponding region illuminated on the reticle 10. By thus causing imprinting on the surface of the substrate 23, the apparatus of FIG. 2 achieves “transfer” of the pattern image from the reticle 10 to the substrate 23.

The components of the depicted electron-optical system situated between the reticle 10 and the substrate 23 collectively are termed the “projection-optical system.” The substrate 23 is situated on a substrate stage 24 situated downstream of the projection-optical system. As the patterned beam propagates through the projection-optical system, the beam actually travels in a downstream direction through an axially aligned “beam tube” (not shown but well understood in the art) that can be evacuated to a desired vacuum level.

The projection-optical system forms a crossover C.O. of the patterned beam on the optical axis Ax at the rear focal plane of the first projection lens 15. The position of the crossover C.O. on the optical axis Ax is a point at which the axial distance between the reticle 10 and substrate 23 is divided according to the demagnification factor. Situated between the crossover C.O. (i.e., the rear focal plane) and the reticle 10 is a contrast-aperture diaphragm 18. The contrast-aperture diaphragm 18 comprises an aperture plate that defines an aperture. With the contrast-aperture diaphragm 18, electrons of the patterned beam that were scattered during transmission through the reticle 10 are blocked so as not to reach the substrate 23.

A backscattered-electron (BSE) detector 22 is situated immediately upstream of the substrate 23. The BSE detector 22 is configured to detect and quantify electrons backscattered from certain marks situated on the upstream-facing surface of the substrate 23 or on an upstream-facing surface of the substrate stage 24. For example, a mark on the substrate 23 can be scanned by a beam that has passed through a corresponding mark pattern on the reticle 10. By detecting backscattered electrons from the mark at the substrate 23, it is possible to determine the relative positional relationship of the reticle 10 and the substrate 23.

The substrate 23 is mounted to the substrate stage 24 via a wafer chuck (not shown but well understood in the art), which presents the upstream-facing surface of the substrate 23 in an XY plane. The substrate stage 24 (with chuck and substrate 23) is movable in the X and Y directions. Thus, by simultaneously scanning the reticle stage 11 and the substrate stage 24 in mutually opposite directions, it is possible to transfer-expose each subfield within the optical field of the illumination-optical system as well as each subfield outside the optical field to corresponding regions on the substrate 23. The substrate stage 24 also includes a “position detector” 25 configured similarly to the position detector 12 of the reticle stage 11.

Each of the lenses 2, 3, 9, 15, 19 and deflectors 5, 8 is controlled by a controller 31 via a respective coil-power controller 2a, 3a, 9a, 15a, 19a and 5a, 8a. Similarly, the reticle stage 11 and substrate stage 24 are controlled by the controller 31 via respective stage drivers 11a, 24a. The position detectors 12, 25 produce and route respective stage-position signals to the controller 31 via respective interfaces 12a, 25a each including amplifiers, analog-to-digital (A/D) converters, and other circuitry for achieving such ends. In addition, the BSE detector 22 produces and routes signals to the controller 31 via a respective interface 22a.

From the respective data routed to it, the controller 31 ascertains, inter alia, any control errors of the respective stage positions as a subfield is being transferred, and actuates appropriate control or restorative measures as required. Thus, a reduced image of the illuminated subfield on the reticle 10 is transferred accurately to the desired target position on the substrate 23. This real-time correction is made as each respective image of a subfield is transferred to the substrate 23, and the subfield images are positioned such that they are stitched together properly on the substrate 23.

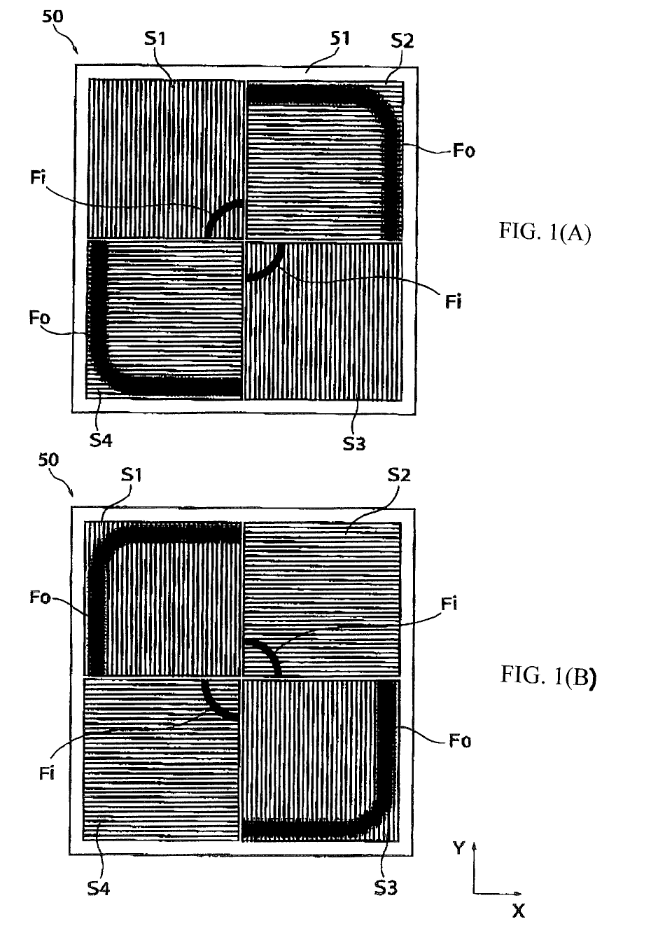

Astigmatism of a system such as that shown in FIG. 2 is evaluated using an astigmatism-evaluation pattern 50 according to a first representative embodiment, as shown in FIGS. 1(A)-1(B). The evaluation pattern 50 in this embodiment includes a large number of thin, parallel “light” and “dark” elements termed “line-and-space” (L/S) elements. The evaluation pattern 50 is created by splitting a subfield 51 into two subunits in the X direction and two subunits in the Y direction, thereby forming four rectangular regions S1, S2, S3, S4. Each region S1-S4 defines a large number of respective L/S elements. By way of example, the subfield 51 has edge dimensions of 1 mm on the reticle, and 0.25 mm as projected onto the substrate (wafer). The individual lines and spaces have equal linewidths, wherein each individual linewidth is near the resolution limit of the electron-beam microlithography system (e.g., 70 nm on the wafer). In the evaluation pattern 50, the L/S elements extend in the X direction in the regions S2 (in the upper right in the figure) and S4 (in the lower left in the figure). The L/S elements extend in the Y direction in the regions S1 (in the upper left in the figure) and S3 (in the lower right in the figure).

In an example, the evaluation pattern 50 was transfer-exposed onto a resistcoated wafer using an electron-beam microlithography apparatus such as that shown in FIG. 2. Surprisingly, the images as formed on the wafer revealed useful features that could be observed and evaluated using a simple optical microscope rather than a complex SEM. In this example, the resulting resist pattern as formed on the wafer was observed using a 100×optical microscope employing white light for illumination. The resist pattern revealed dark “shadow” regions Fo or Fi (FIGS. 1(A)-1(B)). Although shown in FIGS. 1(A)-1(B), individual lines and spaces of the evaluation pattern were not resolvable using the optical microscope due to their being below the resolution limit of the microscope. The microscope image was displayed on a monitor using an ITV camera with adjusted contrast. The “shadow” regions Fo, Fi are peculiar to a negative-resist image of an L/S grid in which pattern-element resolution is relatively adequate. The shadow regions Fo, Fi arise from the distribution of cumulative electron dose from the center of the subfield toward the periphery, and from an increased linewidth near the center of the subfield. This condition creates small arcuate shadow regions Fi located in the center of the subfield (the greater the resolution, the smaller the radius of the arcuate shadow regions). As resolution decreases, the arcs shift toward the periphery of the subfield (shadow regions Fo in the figure). Further decreases in resolution cause the entire image of the evaluation pattern to appear dark (in a negative resist).

In FIGS. 1(A)-1(B), the arc-shaped shadow regions Fo, Fi appear differently depending upon the direction of the L/S pattern, due to the influence of astigmatism on direction of blur. If astigmatism is present that causes the image to extend in a certain X-Y direction that is substantially the same as the longitudinal direction of the L/S pattern, then the linewidth essentially is unchanged by the astigmatism and the resolution remains adequate. However, if the astigmatism is 90° to the longitudinal direction of the L/S pattern, then the astigmatism causes an increase in the linewidth of the projected pattern, with a corresponding decrease in resolution.

Hence, FIG. 1(A) depicts a situation in which astigmatism extending in the Y direction is present. This astigmatism increases the linewidth (as projected) of L/S lines extending in the X direction, while L/S lines extending in the Y direction essentially are unaffected by the astigmatism. Consequently, the resolution of individual L/S pattern elements in the upper right region S2 and the lower left region S4 is reduced, while the resolution of individual L/S pattern elements in the upper left region S1 and the lower right region S3 is unchanged. As indicated in the figure, in the upper right and lower left regions S2 and S4, respectively, the arcs of the respective shadow regions Fo are situated near the periphery of the subfield 51 (where image “lightness” is least). In the upper left and lower right regions S1 and S3, respectively, the arcs of the respective shadow regions Fi are situated near the center of the subfield.

FIG. 1(B) depicts a situation in which astigmatism extending in the X direction is present. This astigmatism increases the linewidth (as projected) of L/S lines extending in the Y direction, while L/S lines extending in the X direction essentially are unaffected by the astigmatism. Consequently, the resolution of individual L/S pattern elements in the upper left region S1 and the lower right region S3 is reduced, while the resolution of individual L/S pattern elements in the upper right region S2 and the lower left region S4 is unchanged. As indicated in the figure, in the upper left and lower right regions S1 and S3, respectively, the arcs of the respective shadow regions Fo are situated near the periphery of the subfield 51 (where image “lightness” is least). In the upper right and lower left regions S2 and S4, respectively, the arcs of the respective shadow regions Fi are situated near the center of the subfield.

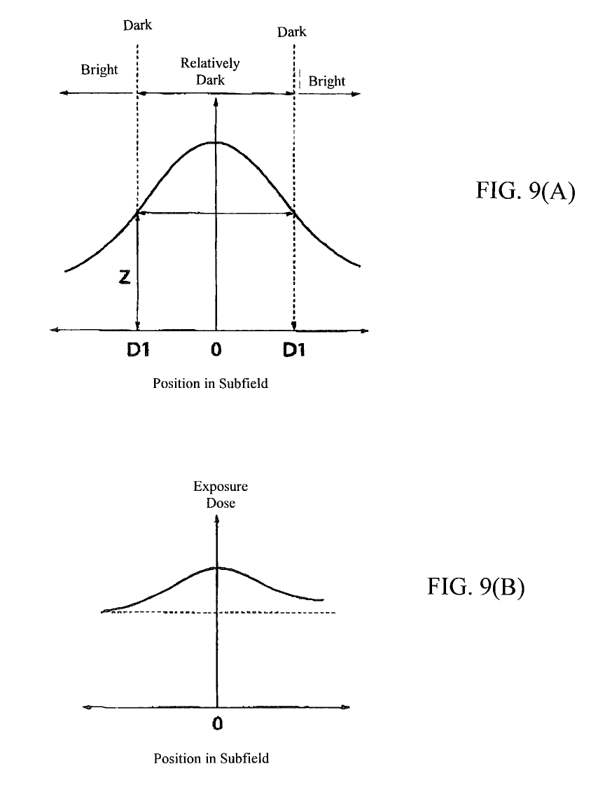

The mechanism by which the shadow regions occur is shown schematically in FIG. 9(A), depicting a distribution of mean residual resist thickness in a subfield. FIG. 9(B) depicts a corresponding distribution of exposure dose in a subfield as projected onto the wafer. The abscissa in FIGS. 9(A) and 9(B) is position within a subfield (wherein “0” is the center of the subfield). The ordinate in FIG. 9(A) is mean thickness of residual resist. The ordinate in FIG. 9(B) is exposure dose.

The occurrence of a shadow region appears to be mediated by the thickness of the residual resist on the wafer and by the spectrum of illumination light used with the optical microscope for observing the images of the evaluation pattern, according to the following relationship. If d denotes the mean thickness of the residual resist on the wafer, λ denotes the mean wavelength of the illumination light, and n denotes the refractive index, then d=1/2n·(N+1/2)·λ (wherein N is an integer, and N−0 in this case). The threshold mean thickness of resist in which a shadow region occurs is indicated by “Z” in FIG. 9(A). The occurrence of a shadow region is affected by the spectrum of light-sensitivity for the human eye (or by the photosensitive spectrum for CCD or ITV cameras).

The shadow regions Fi in the upper left and lower right regions in FIG. 1(A) and in the upper right and lower left regions in FIG. 1(B) have an arcuate shape near the center of the subfield 51. Because the direction of the L/S pattern and the direction of minimal blur due to astigmatism are identical in these regions, the shadow region is unaffected by the aberration. Therefore, the occurrence of the shadow regions in this case appears to be caused by a proximity effect arising whenever the mean residual film thickness near the center of the subfield is at or above a prescribed thickness (“Z”). In such an instance, in the plane of FIG. 9(A), shadow regions appear at locations displaced a distance D1 from the center of the subfield. At D1, the image of the shadow region is darkest (with a negative resist). Further with respect to a negative resist, the image is relatively dark from D1 toward the center of the subfield, and lightens from D1 further toward the periphery of the subfield.

The reason shadow regions appear at the center of a subfield appears to be due to the manner in which the proximity effect manifests itself. In FIG. 9(B), in the absence of the proximity effect, the exposure dose is distributed constantly in the subfield, as indicated by the dotted line. On the other hand, in the presence of the proximity effect, the distribution of exposure dose exhibits a peak at the center of the subfield, as indicated by the solid-line curve.

As described above, the exposure dose in a subfield exhibits a distribution due to the proximity effect. The mean residual film thickness increases near the center of the subfield according to this distribution. Thus, the mean residual film thickness is distributed so as to have a peak located near the center of the subfield in the plane of the subfield. The thickness decreases outwardly from the center in a radial direction.

The shadow regions Fo appearing in the upper right and lower left regions in FIG. 1(A) and in the upper left and lower right regions in FIG. 1(B) are located near the periphery of the subfield 51. In these shadow regions, the direction of the L/S pattern elements and the direction of blur caused by the astigmatism intersect each other orthogonally. This causes the mean residual film thickness to increase. The combined influence of the proximity effect and the aberration causes an increase in mean residual film thickness, which causes the distribution of mean residual thickness in the subfield to shift upward. In a negative resist, the dark regions appear to be produced by interference as the mean residual film thickness reaches the prescribed thickness Z in subfield regions located outwardly from the position D1.

The greater the aberration, the greater the tendency of the arcuate shadow regions to be formed near the periphery of the subfield. Similarly, the greater the aberration, the greater the extent to which the mean residual film thickness is incremented. Whenever the increment, created by the proximity effect, is added to the distribution of mean residual film thickness having a peak in the center of the subfield, the distribution exhibits a gradual upward shift. As the increment due to aberration increases, the position at which the mean residual film thickness is Z is shifted outward from the center (0) according to the distribution described above, which causes the shadow regions to be formed toward the periphery of the subfield.

In the absence of any aberration and whenever the resolution of L/S pattern elements on the resist is adequate, the substrate side of the resist is exposed to the spaces, which causes the pattern image to become lighter. On the other hand, if resolution is degraded due to an astigmatism, the lines overlap and the resist material tends to remain, which causes the entire pattern (as imaged on a negative resist) to become darker. This phenomenon as described occurs with a negative resist. In the case of a positive resist, spaces in the L/S pattern are exposed rather than lines being exposed with a negative resist. Hence, with a positive resist the pattern image becomes lighter as resolution is degraded.

Therefore, with a negative resist the greater the resolution, the lighter the pattern, and the smaller the radius of the dark region. As resolution is degraded, the imaged pattern becomes darker, and the radius of the dark region increases toward the periphery of the subfield. The overall dark image suppresses the occurrence of shadow regions.

Another apparent reason for the occurrence of arc-shaped shadow regions is a change in line (or space) width of the L/S pattern caused by the proximity effect or by astigmatism. The width change results in a diffraction effect, which forms the shadow regions whenever the pattern is observed under an optical microscope.

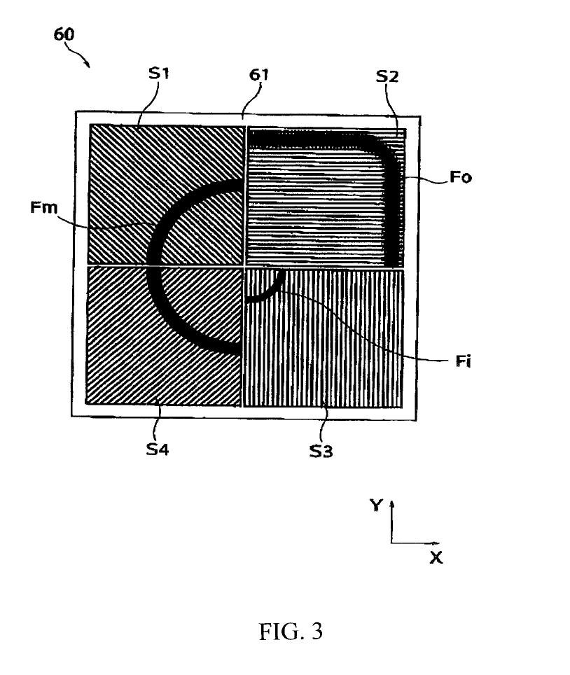

FIG. 3 depicts the orientation of L/S elements in the evaluation pattern and the resulting shadow regions as observed in a second representative embodiment. The evaluation pattern 60, similar to the evaluation pattern 50 of FIGS. 1(A)-1(B), comprises four rectangular regions S1, S2, S3, S4 in the subfield 61, each region containing a respective large number of L/S pattern elements. In this pattern, the L/S elements extend in the X direction in the upper right region S2 of the subfield; extend in the Y direction in the lower right region S3, extend in a −45° direction in the upper left region S1, and in a +45° direction in the lower left region S4.

Observation of the resist pattern to which this evaluation pattern 60 is transferred desirably is performed using an optical microscope as described above. In the presence of astigmatism extending in the Y direction, the shadow region Fo extends along the periphery of the upper right region S2, similar to what is shown in FIG. 1(A). In the lower right region S3, the shadow region Fi is situated near the center of the subfield. In the upper left and lower left regions S1 and S4, respectively, the lines extending diagonally are affected equally by an equivalent astigmatism. As a result, a shadow region Fm occurs at a radial distance mid-way between the peripheral shadow region Fo and the central shadow region Fi.

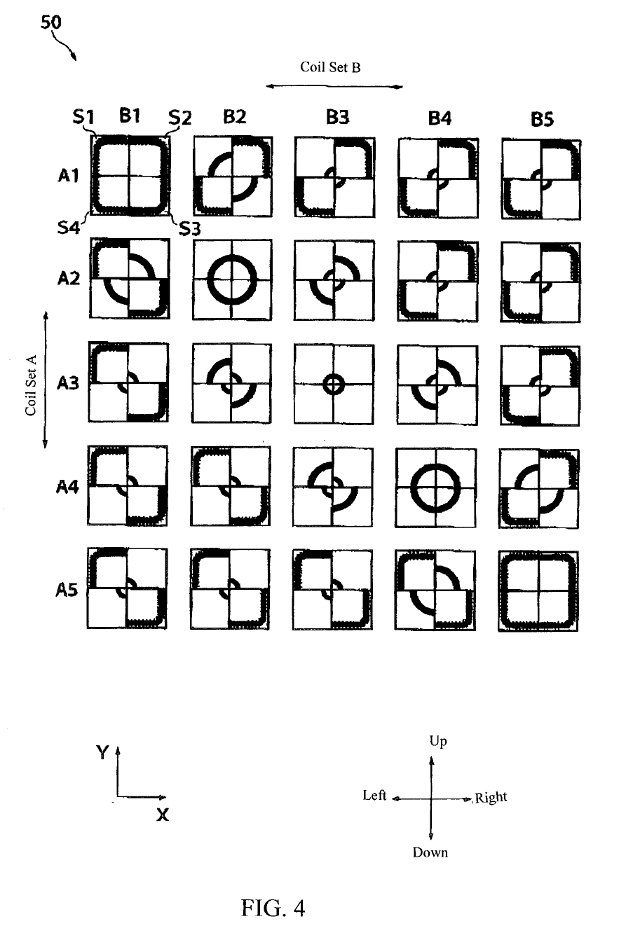

FIG. 4 shows various shadow-region patterns formed on a resist exposed while changing the supply-current parameters for the two coil sets in the stigmator. The evaluation pattern used in this case is as shown in FIG. 1(A).

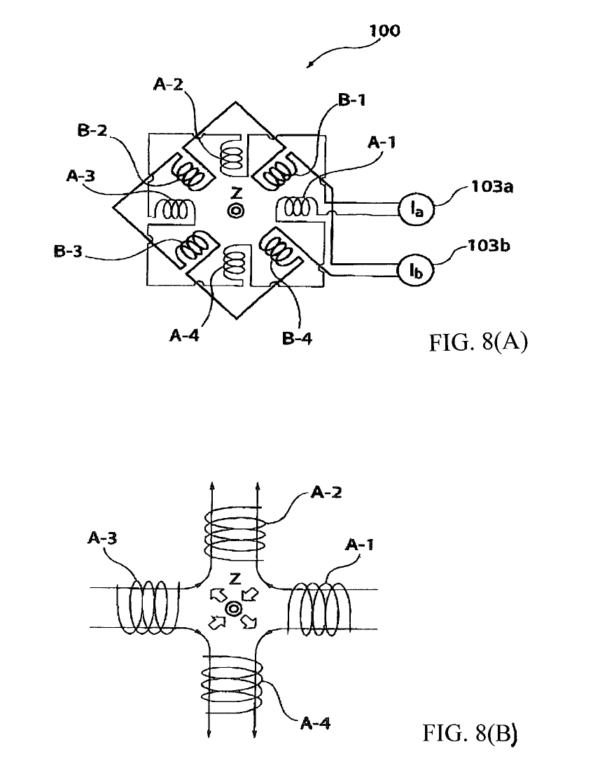

Using a stigmator as shown in FIG. 8(A), the current supplied to the set of coils A-1 to A-4 is increased in five steps from A1 to A5 in FIG. 4. The current supplied to the set of coils B-1 to B-4 similarly is increased in five steps from B1 to B5 in FIG. 4. Thus, respective subfields are exposed in 5×5=25 different conditions representing respective permutations of the respective currents supplied to each set of coils of the stigmator. For the “A” set of coils aberration is adjusted to cause the image to extend in a 45° to 135° direction; for the “B” set of coils aberration is adjusted to cause the image to extend in the X and Y directions. The optical microscope used for pattern observations is as described above.

As indicated in FIG. 4, increasing the current supplied to the “A” coils and the “B” coils causes corresponding changes in the shapes of the shadow regions that are produced in the four regions of the imaged evaluation pattern. The changes are due to changes in the direction and magnitude of the aberration to be corrected (due to the geometry of the coils in the astigmatism-correction coils of the stigmator) and to the respective currents supplied to the coils.

In this example, whenever the current supplied to the “A” coils is A3 and the current supplied to the “B” coils is B3 (i.e., at the center of the figure), the resulting shadow region appear collectively as a single ring having a relatively small diameter at the center of the subfield image. These conditions are interpreted as producing the smallest aberration. Thus, by varying the current supplied to the coils in the stigmator, conditions producing the smallest-diameter dark ring and the greatest “lightness” are determined.

These observations can be performed very efficiently using an optical microscope.

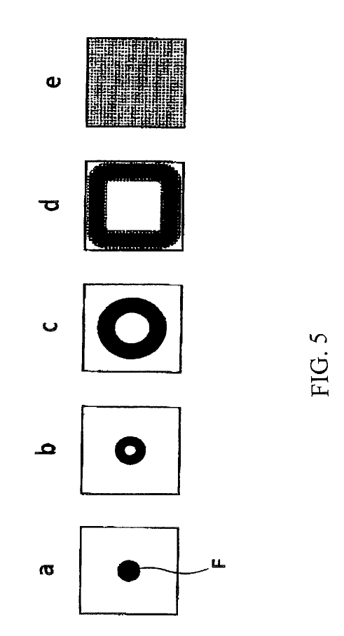

FIG. 5 depicts changes in the profile of shadow regions observed with corresponding changes in the focal position of an imaged evaluation pattern. The focal position is varied by changing the current supplied to the projection lenses 15, 19 in the system shown in FIG. 2. The figure illustrates cases in which no astigmatism is present. The shadow region F appears as a single spot or contiguous ring in the subfield, depending upon the focal position of the image.

Changing focus under a condition in which no astigmatism is present causes shadow regions to be formed solely by the proximity effect. Whenever the image is at best focus (part “a” of FIG. 5), the shadow region F is situated in the center of the subfield and appears as a spot. Because resolution is favorable under this condition, the entire evaluation-pattern image, as projected onto a negative resist, is light. As focus is varied progressively away from best focus, the shadow region F expands to a ring shape that progressively increases in diameter, due to a proximity effect, to near the periphery of the subfield image, according to a corresponding distribution of linewidth increments (parts “b”-“d” of FIG. 5). Ultimately (part “e” of FIG. 5), no distinct shadow regions are evident as the entire image darkens.

Therefore, as the respective currents supplied to the two sets of coils in the stigmator are varied, corresponding changes are made to the direction of blur due to astigmatism. The image in which the diameter of the shadow region is smallest is regarded as representing the lowest aberration. Under such a condition the current supplied to the focusing-adjustment coil is varied. The position of optimal focus is the position at which image lightness and darkness on the entire subfield are equalized and the diameter of the shadow region is smallest.

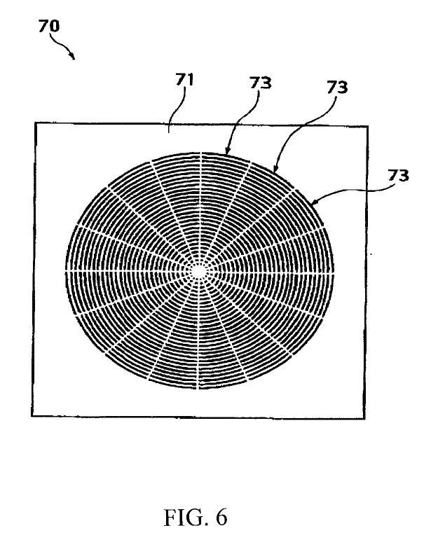

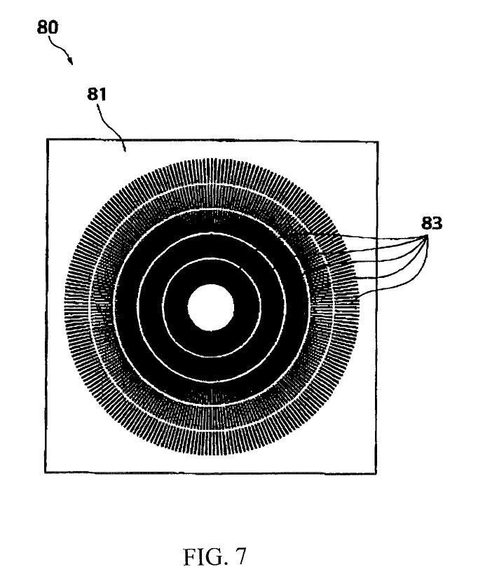

FIGS. 6 and 7 are plan views of alternative evaluation patterns 70, 80, respectively, according to a third representative embodiment. The evaluation pattern 70 of FIG. 6 has a circular patterned region centrally located in the subfield 71. This patterned region is divided into sixteen sub-regions 73. In each sub-region 73, L/S elements are disposed such that they extend circumferentially. By way of example, the width of a single line or space is 0.1 μm.

The evaluation pattern 80 shown in FIG. 7 also is configured as a circular patterned region centrally located in the subfield 81. This patterned region is subdivided into five concentric, ring-shaped sub-regions 83. In each sub-region 83, L/S elements are disposed such that they extend in a radial direction. By way of example, the width of a line or a space is 0.1 μm.

The evaluation patterns 70, 80 also can be used to determine the direction and magnitude of astigmatism by observing the shapes of shadow regions produced when the patterns are projection-exposed.

The embodiments described above were described in the context of charged-particle-beam (notably electron-beam) microlithography (“exposure”) apparatus. However, the general principles described above also are applicable to extreme-ultraviolet (EUV), X-ray, and optical microlithography apparatus. Also, the reticle is not limited to a transmissive-type reticle, but alternatively can be a reflective-type reticle.

Whereas the invention has been described in connection with multiple representative embodiments, the invention is not limited to those embodiments. On the contrary, the invention is intended to encompass all modifications, alternatives, and equivalents as may be included within the spirit and scope of the invention, as defined by the appended claims.

What is claimed is:

1. In a microlithography method in which a device pattern to be transferred to a photosensitive substrate is defined on a reticle situated at a reticle plane, and a region of the reticle is illuminated with an illumination beam to form a patterned beam that carries an image, via a projection-optical system, of the illuminated region to the photosensitive substrate so as to form an image of the illuminated region on the photosensitive substrate, a method for determining an image-forming performance of the projection-optical system, comprising:
disposing an evaluation pattern at the reticle plane, the evaluation pattern comprising multiple groups of line-and-space (L/S) pattern elements, each group comprising multiple L/S pattern elements extending in a respective direction that intersects a respective direction, in the reticle plane, of L/S pattern elements in another of the groups;
lithographically imaging the evaluation pattern on a resist-coated substrate;
developing the resist on the substrate to form in the resist an imprinted image of the evaluation pattern;
observing a shadow region in the imprinted image of the evaluation pattern; and
from an observed profile of the shadow region, determining the image-forming performance.

2. The method of claim 1, wherein the image-forming performance is focus or astigmatism, or both.

3. The method of claim 1, wherein the L/S pattern elements have a linewidth at or near a resolution limit of the projection-optical system

4. The method of claim 1, wherein:
the evaluation pattern is divided into multiple regions;
each region comprises a respective group of L/S pattern elements; and
the respective L/S pattern elements in each of at least two regions are oriented differently from each other in respective directions that intersect each other in the reticle plane.

5. The method of claim 4, wherein the respective L/S pattern elements in each of at least two regions are oriented perpendicularly to each other.

6. The method of claim 4, wherein the respective L/S pattern elements in each region are oriented parallel to each other.

7. The method of claim 1, wherein:
the evaluation pattern is divided into multiple regions each comprising a respective group of L/S pattern elements; and
in each group of L/S pattern elements, the constituent L/S pattern elements extend radially relative to a center of the subfield.

8. The method of claim 1, wherein:
the evaluation pattern is divided into multiple regions each comprising a respective group of L/S pattern elements; and
in each group of L/S pattern elements, the constituent L/S pattern elements extend circumferentially relative to a center of the subfield.

9. The method of claim 1, wherein the observing step is performed using an optical microscope.

10. The method of claim 1, wherein the shadow regions arise from a gradual increase or decrease in a linewidth of the as-imaged L/S pattern due to a proximity effect caused by different cumulative exposure energies from a center of the imprinted image to a perimeter of the imprinted image of the evaluation pattern.

11. The method of claim 1, wherein:
the shadow region has at least one arc-shaped profile having a respective radius; and
the radius decreases with increasing resolution with which the evaluation pattern is imaged lithographically from the reticle to the substrate, resulting in a positional shift of the shadow region, with increasing resolution, toward a center of the imprinted image of the evaluation pattern.

12. The method of claim 11, wherein:
the multiple groups of L/S pattern elements are disposed around a center of the evaluation pattern; and
the image-forming performance pertains to astigmatism that is determined by observing an increased radius of a respective arc-shaped profile in a first location of the imprinted evaluation pattern at which a blur direction caused by the astigmatism is similar to a direction in which L/S pattern elements in the first location extend, and observing a decreased radius of a respective arc-shaped profile in a second location of the imprinted evaluation pattern at which a blur direction caused by the astigmatism is approximately 90° to the direction in which L/S pattern elements in the first location extend.

13. The method of claim 11, wherein:
the image-forming performance pertains to focus;
the shadow region has a ring-shaped profile of which a radius is a function of focus; and
focus is determined by observing the radius of the ring-shaped profile of the shadow region.

14. The method of claim 13, wherein the radius is a function of the extent to which an image-forming capacity of the resist matches a position of the resist in an axial direction.

15. The method of claim 1, wherein the shadow region has an arc-shaped profile having a radius that is a function of a resolution with which the L/S pattern elements have been imaged in at least one direction on the photosensitive substrate.

16. The method of claim 1, wherein the shadow region has an arc-shaped profile having a radius that is a function of a blur accompanying imaging of the L/S pattern elements in at least one direction on the photosensitive substrate.

17. The method of claim 1, wherein:
the resist is a negative resist;
the image of the evaluation pattern is being formed in the resist at an incident dose greater than a pivotal-point dose for the resist; and
the darker the image, the lower a resolution at which the evaluation pattern was imaged onto the substrate.

18. The method of claim 1, wherein:
the resist is a positive resist;
the image of the evaluation pattern is being formed in the resist at an incident dose less than a pivotal-point dose for the resist; and
the darker the image, the lower a resolution at which the evaluation pattern was imaged onto the substrate.

19. In a microlithography method performed using a microlithography apparatus in which a device pattern to be transferred to a photosensitive substrate is defined on a reticle situated at a reticle plane, and a region of the reticle is illuminated with an illumination beam to form a patterned beam that carries an image, via a projection-optical system, of the illuminated region to the photosensitive substrate so as to form an image of the illuminated region on the photosensitive substrate, a method for determining and adjusting an imaging-forming performance of the microlithography apparatus, comprising:
setting a condensing power of the projection-optical system;
setting a focus with which the image of the illuminated region is imaged on the photosensitive substrate;
setting an astigmatism with which the image of the illuminated region is imaged on the photosensitive substrate;
disposing an evaluation pattern at the reticle plane, the evaluation pattern comprising multiple groups of line-and-space (L/S) pattern elements, each group comprising multiple L/S pattern elements extending in a respective direction that intersects a respective direction, in the reticle plane, of L/S pattern elements in another of the groups;
lithographically imaging the evaluation pattern on a resist-coated substrate multiple times, wherein in each time at least one of focus and astigmatism is changed, so as to form multiple respective images of the evaluation pattern on the photosensitive substrate at various respective settings of focus and astigmatism;
developing the resist on the substrate to form in the resist respective imprinted images of the evaluation pattern;
observing respective shadow regions in the imprinted images of the evaluation pattern; and
from respective observed profiles of the shadow regions, determining and selecting desired settings of focus and astigmatism.

20. The method of claim 19, wherein the L/S pattern elements have a linewidth at or near a resolution limit of the projection-optical system

21. The method of claim 19, wherein
the multiple groups of L/S pattern elements are disposed around a center of the evaluation pattern; and
astigmatism that is determined by observing an increased radius of a respective arc-shaped profile in a first location of the imprinted evaluation pattern at which a blur direction caused by the astigmatism is similar to a direction in which L/S pattern elements in the first location extend, and observing a decreased radius of a respective arc-shaped profile in a second location of the imprinted evaluation pattern at which a blur direction caused by the astigmatism is approximately 90° to the direction in which L/S pattern elements in the first location extend.

22. The method of claim 19, wherein:
the shadow region has a ring-shaped profile of which a radius is a function of focus; and
focus is determined by observing the radius of the ring-shaped profile of the shadow region.

23. The method of claim 19, wherein the step of observing respective shadow regions is performed using an optical microscope.
